(19) United States
(12) Patent Application Publication
(10) Pub. No.: US 2024/0342707 A1
(43) Pub. Date: Oct. 17, 2024

(54) SAMPLE CARRIER, USE THEREOF, AND METHODS, IN PARTICULAR FOR DETECTING PATHOGENS

(71) Applicant: CARL ZEISS MICROSCOPY GMBH, Jena (DE)

(72) Inventors: Horst Wolff, Siegsdorf (DE); Rebecca Elsaesser, Jena (DE)

(21) Appl. No.: 18/292,527

(22) PCT Filed: Jul. 19, 2022
(86) PCT No.: PCT/EP2022/070170

§ 371 Date: Jan. 26, 2024

(30) Foreign Application Priority Data
Jul. 29, 2021 (DE) 10 2021 208 185.1

(51) Int. Cl. B01L 3/00

(52) U.S. Cl. CPC B01L 3/502715; B01L 2200/0647; B01L 2200/16; B01L 2300/0663; B01L 2300/0681

(57) ABSTRACT

The disclosure relates to a sample carrier, the use thereof, and methods, in particular for detecting pathogens. The sample carrier has a sample chamber for receiving a sample, which chamber is enclosed by a wall, and an access opening for filling the sample chamber with the sample; the wall has at least one region which is transparent to detection radiation coming from the sample and acts as a detection window. According to the invention, the sample chamber has, in a direction perpendicular to the transparent region of the wall, a clear distance between the opposing inner faces of the wall of at most 50 μm, in particular, at most 25 μm.

### CROSS REFERENCE TO RELATED APPLICATIONS

This application is a 35 U.S.C. § 371 National Phase Entry Application from PCT//EP2022/070170, filed Jul. 19, 2022, designating the U.S., and claims the benefit of German Application No. 10 2021 208 185.1, filed Jul. 29, 2021, the disclosures of which are incorporated herein by reference in their entireties.

### FIELD OF THE INVENTION

The invention relates to a sample carrier according to the preamble of the main claim, to the use thereof, and to a method for capturing detection radiation from the sample.

### BACKGROUND

The object of imaging in a number of applications of microscopic methods is not that of enabling a detailed understanding of the structure of an object but rather that of determining a presence or lack of presence of for example a certain type of cell, an organelle and/or other, usually biological objects. For this reason, the use of a light microscope is desirable in such cases, firstly due to the simpler handling and secondly for reasons of lower equipment costs vis-à-vis high-resolution microscopes.

However, an obstacle to the use of a conventional light microscope if very small objects should be detected is that such objects may be smaller, or are smaller, than the resolution limit of a light microscope. For example, viruses typically have sizes of between 15 and 440 nm. Thus, the pathogen causing the viral disease COVID 19 (coronavirus disease 19), the virus denoted SARS-COV-2, has a size of between 60 and 160 nm. Other pathogens such as chlamydia and mycoplasma have a size of between 150 nm and approximately 800 nm.

Biological objects, in particular, can be provided with specific markings, for example proteins or probes (henceforth also: markers), which emit a detection radiation. These specific markings enable a visualization of the objects even if the latter are not optically resolved but only depicted as fluorescent points. In principle, the presence of the objects can be detected in this way and the concentration thereof (titer) can optionally be determined.

However, unwanted signals from the sample background may represent a significant problem when capturing marked microscopic objects optically. For example, if the object to be detected is provided with a fluorescent marker, what is known as the background fluorescence of the sample may lead to significant falsification of the optically captured pieces of information. This background fluorescence may result from unbound markers and be triggered by other object in the sample, for example cells or cell fragments. Since small objects such as viruses emit fluorescent signals with only a low signal intensity, the background fluorescence is often very problematic.

The prior art has disclosed technical options for reducing unwanted background signals. Thus, TIRF (total internal reflection fluorescence) microscopy can be used as detection method. As a result of an evanescent field arising in a small space, it is only marked objects in the vicinity of for example a surface of a transilluminated sample carrier that are excited and only the fluorescent radiation emitted thereby that is detected as detection radiation, while the background of the sample is not excited (see DE 10 2005 023 768 B4, for example).

In an alternative, confocal microscopy methods can be used to reduce the background fluorescence; however, slightly less suppression of the background fluorescence is achieved in that case vis-à-vis TIRF microscopy.

Methods from both TIRF microscopy and confocal microscopy are complicated and expensive methods. Moreover, these methods are sensitive to external influences and require sophisticated calibrations which need to be repeated regularly in many cases. On account of their complexity, these methods are not easy to handle and therefore suitable only to a limited extent for routine use, for example in laboratories with high sample throughputs (e.g., screening). The production of equipment for mass diagnosis of small objects such as viruses on the basis of TIRF microscopy or confocal microscopy is therefore practically not implementable in an easy manner.

Microscopy methods that are easier to implement, especially an illumination and detection of a sample in the wide field, generally require specific substrates and sample carriers, the design of which enables a selective detection of signals from only a specific layer of the sample. One such solution from Xfold imaging (https://xfoldimaging.com; Jun. 18, 2021) is optimized to only one wavelength or a few wavelengths and offers significantly weaker effects than TIRF microscopy methods.

### SUMMARY

The invention is based on the object of proposing a further possibility of allowing even very small objects to be detected with a significantly reduced background noise, especially with a reduced background fluorescence. At the same time, the invention should be usable for high sample throughput.

The object is achieved by the subjects of the independent claims. The dependent claims relate to advantageous developments.

One way of achieving the object is by way of a sample carrier comprising at least a sample space which is enclosed by a wall and serves to receive a sample, and an access opening for filling the sample space with the sample. In this case, the wall has at least one region which is transparent to a detection radiation originating from the sample and which acts as detection window.

A sample carrier according to an implementation is characterized in that, in at least one direction perpendicular to the transparent region of the wall, the sample space has a clear distance between the opposing inner sides of the wall, also referred to as side walls hereinbelow, of no more than 50 μm, in particular no more than 25 μm, advantageously of no more than 5 μm, and in particular of no more than 1 μm.

In further advantageous implementations of the sample carrier, the clear distance is no more than 0.8 μm, in particular no more than 0.6 μm, advantageously no more than 0.4 μm, and particularly advantageously no more than 0.2 μm.

An excitation radiation whose effect generates the detection radiation is intended to be radiated into the sample space in particular, wherein unwanted reflections are reduced or even avoided, possibly by way of further technical measures. The detection radiation is advantageously captured using an objective whose depth of field is equal to or greater than the clear distance, with the result that it is advantageously possible to dispense with focusing on a region within the sample space, in particular within the clear distance.

On the side face or an excitation window (see below) on which an excitation radiation is radiated or intended to be radiated, the sample carrier may for this purpose have a filter appropriately matched to the wavelength range of the excitation radiation, the filter for example being in the form of a coating of the side face of the sample carrier, a layer formed by the filter, or a substrate provided with the filter.

An important concept of the invention consists of limiting the sample space in at least one direction such that, in addition to marked objects, there is space for only a few or no further constituents of the sample, from which unwanted optical signals, especially nonspecific fluorescent radiation, radiate. The sample carrier can be used advantageously if the objects to be detected are small in comparison with other constituents of the sample.

For example, a sample can include a liquid medium in particular, in which the objects to be detected are located. For example, such a sample can be a suspension or a gel containing viruses and/or microorganisms in particular.

Within the meaning of this description, the term objects is primarily understood to mean biological objects such as viruses and microorganisms or virus particles such as fragments and envelopes. The techniques described herein also enable the detection of prions (e.g., 10 to 15 nm), cell constituents, organelles, agglomerates (proteins, molecules such as proteins which are biological and/or bound to inorganic constituents), and also inorganic objects should their size be smaller than the clear distance of the sample space. The techniques described herein are advantageously utilizable for the detection of pathogens, which is to say objects that cause disease.

The region of the wall of the sample space acting as a detection window can take up the entire wall or the majority of the wall. In further implementations, the detection window can encircle the sample space in at least one strip or form a portion of the wall. These implementation options for example allow detection radiation to be captured from different directions and/or allow the sample carrier to be rotated and/or pivoted relative to a detection direction. Should an excitation radiation and/or detection radiation pass obliquely through the wall within the scope of a pivoting process, aberrations caused thereby can be corrected by means of optical correction elements and/or by computation within the scope of image processing. Since a high spatial resolution of the acquired image data is not absolutely necessary when detecting fluorescent objects within the scope of this invention, it is advantageously possible to dispense with complex correction measures.

The cause of the detection radiation may be found in the objects to be captured optically emitting a detection radiation themselves or being excited to such an emission. To achieve high specificity of the detection radiation, the objects may be provided with markers, especially with fluorescent markers (fluorophores), which can be selectively excited to emit a specific detection radiation. An excitation radiation, in particular, can be used for excitation purposes. This necessitates the excitation radiation being able to be incoupled, in particular radiated, into the sample space and the detection radiation caused being able to pass through the detection window. To this end, the sample carrier has an excitation window.

In a possible implementation option of the sample carrier, the excitation radiation can be radiated into the sample space through the detection window. A separate excitation window may be present in further implementations. In both cases, the material of the detection window or excitation window must be transmissive to the wavelength or the wavelength range of the excitation radiation.

It is optionally also possible to incouple the excitation radiation via the access opening or an optionally present outlet opening, wherein the access opening or the outlet opening may be considered to be an excitation window in that case.

During practical use of the sample carrier, a medium previously present therein, for example air, sample medium, rinsing medium, etc., and/or a sample previously present therein must be removed, for example, displaced, when the sample space is filled. To this end, the sample carrier may have an outlet opening, through which a medium previously present in the sample space can escape from the sample space when the latter is filled.

In the case of an appropriately dimensioned access opening, a medium present in the sample space may also emerge via a portion of the access opening if a further medium is supplied via another portion of the access opening. This is possible, in particular, when the sample space is embodied in the form of a channel (see below) which has a clear distance of no more than 50 μm in one direction but is dimensioned to be larger in a further direction.

The wall of the sample space can be composed of different elements. For example, side walls made of glass and/or plastic may be present, wherein at least one of the side walls can be in the form of a film while the at least one further side wall has a greater wall thickness than the film.

Such an implementation advantageously combines a high optical transmissivity to the excitation radiation and/or the detection radiation in the region of the side wall made of the film while the at least one further side wall supports the stability of the sample carrier against torsion and/or bending.

Glass and/or plastic can be used as the material of the detection window and/or excitation window The plastic can have a very thin implementation (film), for example with a material strength of less than 1 mm.

Spacers can be inserted between opposing side walls or a raised edge can be applied to or formed on at least one of the side walls, in order to bring about the clear distance between the side walls and keep it constant. For example, a raised edge may be applied in the form of a lacquer or by means of sputtering deposition on the basis of cathode sputtering. In other implementations, a raised edge can be jointly cast during the production of the sample carrier or subsequently be cast on or bonded on. The edge may also be formed by mechanical processing. In principle, the sample space may also be formed by removing material from a solid piece of material. By way of example, methods such as laser ablation, 2-photon methods, etching methods, and/or mechanical methods can be used to this end.

In a further embodiment, the sample carrier can be embodied in the form of a channel present in a carrier, for example, in a carrier plate. In an implementation, the channel can be covered by a side wall in order to create a sample space within the meaning of the invention. The carrier with such a channel and a side wall suitable as a cover can be provided as semifinished products for producing a sample carrier.

In possible implementations of a sample carrier in the form of a channel in a carrier plate, the clear distance from a base of the channel to a support surface, to which a side wall can be applied as part of the wall of the sample space, is no more than 0.2 μm to no more than 50 μm.

In a further implementation of the sample carrier, a channel can be in the form of a slot in a carrier plate. The clear distance of the slot is no more than 0.2 μm to no more than 50 μm, at least in the region of the detection window. If the acting capillary forces are large enough to keep the sample within the slot-shaped channel, it is possible to dispense with a cover for the longitudinal opening of the channel. To this end, the walls of the channel along the longitudinal opening of the slot-shaped channel may have a coating which does not allow wetting by the sample or which can only be wetted with difficulties. Depending on the nature of the sample, the coating could be hydrophobic or lipophobic, for example.

If the channel completely crosses the carrier plate from one end side of the carrier plate to the other, then the channel opening in one end side can serve as an access opening. The other channel opening may optionally act as an outlet opening.

A detection is implemented across the direction of extent of the slot-shaped channel. An excitation radiation can be radiated in through the detection window, but optionally also through the non-covered longitudinal opening of the channel or through the access opening or the outlet opening.

In further implementations, the cross section of a sample carrier, especially the wall thereof, can be flattened on at least one side, semicircular, circular, triangular, quadrilateral, polygonal, for example pentagonal, hexagonal, heptagonal or octagonal, or trapezoidal, at least over the extent of the detection window and orthogonal to this one cross section.

While round or semicircular cross sections allow an excitation and/or detection from different sides of the sample carrier, implementations with polygonal cross sections increase the stability of the sample carrier against loads caused by torsion and/or bending. Some or all side faces of sample carriers with polygonal cross sections can be embodied as detection windows. An implementation of the sample carrier in the form of a tube enables various uses in addition to cost-effective fabrication.

In further implementations, the cross section of a sample carrier is composed of different shapes. Examples of this include semicircular and flattened shapes or combinations of the aforementioned rounded-off and polygonal shapes.

It is also possible that the cross section of an outer shape of the sample carrier differs from the cross section of a shape of the wall of the sample space. For example, the wall of the sample space may have a round cross section while the outer shape for example has a polygonal design.

It is further possible that the cross section of the sample space and/or outer shape changes along the extent of the sample carrier, for example to combine the versatility of a detection window having a round cross-section with an increased stability of polygonal outer shapes.

An improved stability of the sample carrier can also be obtained if at least one stabilization element is present along the outer side of the wall, with the wall being reinforced against deformations as a result of the effect thereof. Such outside reinforcements may be formed by an attached element, for example, an adhesively bonded or welded-on element, for example, made of plastic, metal, or a composite. It is also possible that the sample carrier has at least one corner region formed in reinforced fashion or at least one longitudinal elevation of the material of the wall.

As explained above, the concept of the invention is based essentially on the circumstances of only admitting those objects into the sample space whose presence or lack of presence should in fact be detected. In a development of the design of the sample carrier, a filter element can be arranged at the access opening, the mesh size of which is advantageously no more than 80% of the clear distance and the effect of which prevents larger objects from entering into the sample space. In further implementations of the sample carrier embodied thus, the mesh size is no more than 50% or no more than 25% of the respective clear distance.

In further implementations, a technical measure for restricting the size of the objects reaching the sample space can be realized by virtue of the aperture width of the access opening being smaller than the clear distance of the sample space. In this way, the access opening performs a filter effect on account of its aperture width. The circumstances of the sample space having a larger clear width than the aperture width advantageously avoids high flow resistances when filling the sample space and/or when the sample or a rinsing medium flows through the sample space or restricts a high flow resistance to the region of the access opening.

In an alternative or in addition to a coating for avoiding the emergence of the sample or sample medium from the sample space already described above, at least one region of the inner side of the wall facing the sample space, advantageously the inner side of the detection window, can be provided with a coating for binding, in particular, specifically binding, constituents of the sample. Such a coating can advantageously increase the probability of objects present in the sample, for example of viruses or other pathogens to be detected, being present in the region of the detection window or being concentrated there.

To specifically bind objects to be detected, especially viruses, the coating may contain poly-L-lysine, poly-D-lysine, and/or collagen. In a further implementations, areas on the inner side of the wall can be provided with different coatings in each case, in order to reduce unwanted displacement effects of the objects to be bound. In addition or in an alternative, a coating may contain antibodies which are directed to specific objects and selectively bind the latter.

A sample carrier is provided in particular for uses in which a fluorescent radiation excited in the sample is captured as a detection radiation and is optionally evaluated or intended to be evaluated thereafter. In simple terms, fluorescent radiation is caused by a sufficiently energy-rich excitation radiation leading to the absorption of at least one photon on account of resonance phenomena, in particular, a resonance of a photon of the excitation radiation with an atomic or electronic transition, and a detection radiation with the emission of at least one photon being caused. Therefore, such a generation of the detection radiation is fundamentally different from, for example, processes in which an excitation radiation is scattered and resonance phenomena do not occur or are not relevant to the emission of the detection radiation.

The techniques described herein can be advantageously used to detect viruses or virus particles present in the sample as objects to be detected. Further, implementations can be used to detect correspondingly small microorganisms such as chlamydia, mycoplasma, or other bacteria if their size is smaller than the clear distance and these can be introduced into the sample space and optionally can be transported therethrough. For example, the size of chlamydia and mycoplasma is between 150 nm and approximately 800 nm, while many bacteria have sizes of between 1 μm and 5 μm. Advantageously, the clear distance of the sample space is chosen in accordance with the size of the objects to be detected. To this end, specific markers can be bound to the objects, said markers emitting a detection radiation or being able to be excited to emit a detection radiation. The sample carrier can advantageously be used to detect pathogens such as viruses and optionally be used to determine or estimate a titer of the relevant pathogen for individual samples or for a plurality of samples. In the latter use case, the sample carrier should preferably be cleaned with a rinsing medium following the processing of a sample. The option of cost-effective and standardized production enables a use of sample carriers in mass tests (screening) of entire groups of people or demographic groups.

Radiating—in the excitation radiation and/or capturing the detection radiation can be implemented in a reflected light arrangement or in a transmitted light arrangement. In further implementations, the excitation radiation can be radiated—in in the form of a light sheet.

To obtain a high recording quality and/or sensitivity during the capture of the detection radiation, an objective used to capture the detection radiation can be embodied as an immersion objective. In this case, immersion oils, water or aqueous mixtures can be used as immersion medium. In this case, an immersion used should assist with the transition of the excitation radiation into the sample space such that, for example, unwanted reflections, especially total-internal reflections, of the excitation radiation are advantageously avoided. Within the scope of the invention, the use of an immersion medium advantageously serves to avoid focusing within the sample space.

It is also possible to use solid-body immersions (see US 2015/0241682 A1, for example) or an immersion matrix (DE 10 2017 217 192 A1). By way of their quite simple handling and low device and process engineering complexity, these assist the use of the sample carrier in applications such as screening.

Thus, the sample carrier can be used in a method for capturing detection radiation from a sample. To this end, a sample carrier is provided. The sample is introduced into the sample space via the access opening. If the sample space is preferably free from air bubbles and if a rinsing medium possibly present in the sample space in advance or a buffer medium present for maintaining the activity of an optional coating of regions of the inner sides of the wall has been completely replaced by the sample or the sample medium containing the objects to be detected, then a detection optical unit and a detector is used to capture a detection radiation from the sample through the detection window and said detection radiation is subsequently evaluated. Since the sample space is small and sharply delimited in the direction of the clear distance, there is optionally no need to focus the detection optical unit in the direction of the clear distance. In this case, the depth of field of a detection objective used should exceed the size of the object to be detected, for example the size of a virus in the direction of the clear distance.

In this context, a PMT can be used as detector in the simplest case. In order also to be able to obtain pieces of information for example regarding the spatial distribution, number, and intensity (quantity) of the object emitting the detection radiation in addition to the detection of the presence or lack of presence of a detection radiation that is sufficiently intensive for detection purposes, it is for example possible to use detector arrangements such as PMT arrays or SPAD arrays or two-dimensional detectors such as CCD, CMOS or sCMOS as detector. In addition, or in an alternative, the measured values of the captured detection radiation can be displayed on a display and visually detected by a user.

As already explained further above, the sample situated in the sample space can be illuminated by means of an excitation radiation, wherein the emission of at least one detection radiation is excited by the effect of the excitation radiation. In this case, the detection radiation can be captured while the sample is presented stationarily in the sample carrier. In further designs of the method, the sample can be transported continually or sequentially through the sample space if the sample carrier is intended to be used for a plurality of samples. In the case of a continual transport, the detection radiation can be captured at time intervals or continuously. If the sample is transported sequentially, which is to say with an alternation of transport phases and rest phases, then the detection step can always be carried out at least once whenever a new sample is present in the sample space and the transport has advantageously been interrupted.

The introduction, movement, and/or washing out of the sample can therefore be implemented using methods and technical elements from the field of microfluidics. For example, available pumps, valves, and/or mixers can be designed as micropumps, microvalves and micromixers, respectively. In addition, or in an alternative, the sample carrier can be integrated in what is known as a (microfluidic) chip or can be connected to such a chip. By way of example, necessary marking and/or dyeing actions can be performed on such a chip, for example in separate channels and reaction chambers. The sample prepared thus is subsequently transported via the channels of the chip to the sample carrier. Using such an embodiment, the degree of automation of the use of the sample carrier can advantageously be further increased.

For example, a transport movement of the sample can be generated by virtue of exploiting a capillary effect acting in the sample space on account of the small dimensions. In further designs of the method, the sample can be transported by means of a pump and pressed into or through the sample space. A corresponding statement applies to the generation of a negative pressure and a suctioning—in of the sample.

If the sample or a plurality of samples is transported through the sample space, there is a repetition of an optional excitation by means of the excitation radiation, especially whenever a charge of the sample space is replaced by a further charge during a continual transport.

Before a sample is introduced into the sample space for the first time, or between the introduction of a sample and the introduction of a further sample, the sample space can be freed from residues of the preceding sample using a rinsing medium.

In the case of a detection method for viruses and/or microorganisms, it is particularly desirable to not obtain any false-negative measurement results where possible, which is to say that the actual presence of for example a viral load can be detected with great reliability. To this end, it may be helpful if the sample carrier is moved, especially rotated and/or tilted, while the detection radiation is captured and/or between two capturing processes for the detection radiation, with the result that detection radiation is in each case captured or can in each case be captured from different regions of the wall (detection window).

### BRIEF DESCRIPTION OF THE DRAWINGS

The invention is explained in more detail below on the basis of exemplary implementations and drawings, in which:

FIG. 1 shows a schematic illustration of a sample carrier in a sectional illustration and a detection optical unit according to the prior art;

FIG. 2 shows a schematic illustration of a first exemplary implementation of a sample carrier in a sectional illustration, and a detection optical unit;

FIG. 3 shows a schematic illustration of a second exemplary implementation of a sample carrier in a sectional illustration, and a detection optical unit, a controller, and a pump;

FIG. 4 shows a schematic illustration of a third exemplary implementation of a sample carrier in a perspective view;

FIG. 5 shows a schematic illustration of a fourth exemplary implementation of a sample carrier on a chip in a perspective view;

FIG. 6 shows a schematic illustration of a fifth exemplary implementation of a sample carrier in a perspective view;

FIG. 7 shows a schematic illustration of a sixth exemplary implementation of a sample carrier in a side view;

FIG. 8 shows a schematic illustration of the sixth exemplary implementation of a sample carrier in a perspective view;

FIGS. 9a to 9h show schematic illustrations of different cross sections of the sample carrier;

FIG. 10 shows a schematic illustration of a seventh exemplary implementation of a sample carrier with an outside reinforcement in a sectional illustration;

FIG. 11 shows a schematic illustration of an eighth exemplary implementation of a sample carrier with an inside reinforcement in a sectional illustration;

FIG. 12 shows a schematic illustration of a ninth exemplary implementation of a sample carrier with an outside reinforcement in a sectional illustration; and

FIG. 13 shows a schematic illustration of a tenth exemplary implementation of a sample carrier with an outside reinforcement in a sectional illustration.

In the schematically depicted exemplary implementations and in the example from the prior art, the same technical elements are respectively provided with the same reference signs.

### DETAILED DESCRIPTION

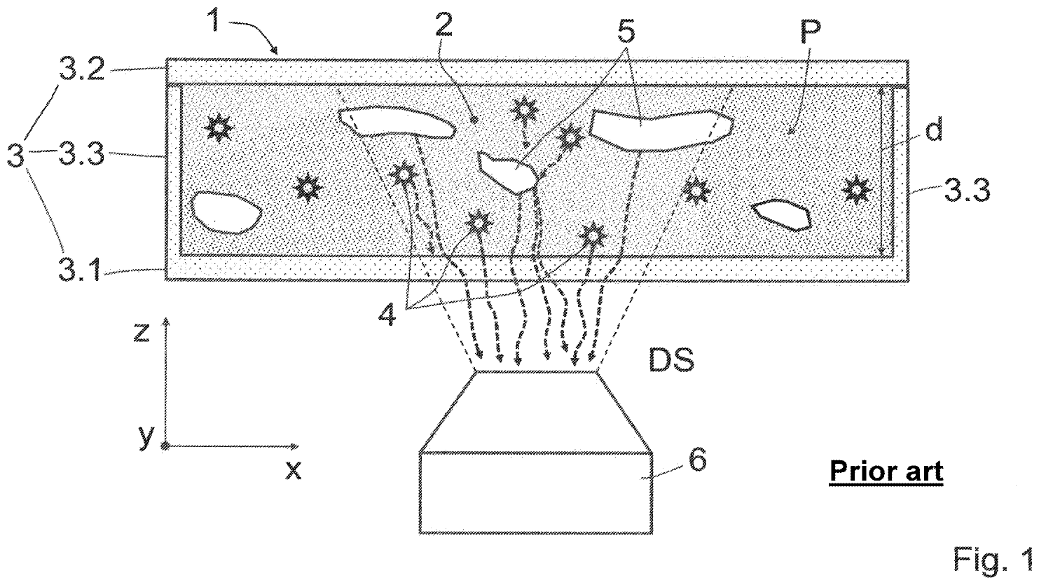

FIG. 1 shows a longitudinal section of a sample carrier 1, as is known from the prior art. In this case, a sample space 2, into which a sample P can be introduced, is enclosed by a wall 3 which comprises at least a first side wall 3.1 and a second side wall 3.2 and third side walls 3.3. Together with the third side walls 3.3, the first side wall 3.1 forms a container that is open to one side, while the second side wall 3.2 can be placed onto the third side walls 3.3 and hence covers the open side of the sample space 2. The sample space 2 has a clear distance d between the inner side of the base of the first side wall 3.1 facing the sample space 2 and the inner side of the second side wall 3.2.

The sample P situated in the sample space 2 contains viruses provided with a marker as objects 4 to be detected. Moreover, unbound markers, cells, cell fragments (debris), aggregates and similar structures may be situated in the sample P; in overarching fashion, these are provided with the reference sign “5” (henceforth simplified to debris 5). The objects 4 and the possibly present debris 5 may be present in an aqueous solution (depicted by a dense point hatching) of the sample P.

The markers of the marked objects 4 emit a detection radiation DS which may be a fluorescent radiation in particular and which is captured through the first side wall 3.1 and within the numerical aperture (symbolized by two thin dashed lines) of a detection objective 6 by means of said objective.

To denote relative positional relationships, a Cartesian coordinate system is plotted. In this case, the base area of the sample carrier 1 extends in a plane spanned by the x-axis and the y-axis while the detection radiation DS is captured along the z-axis.

It is easy to identify from FIG. 1 that the detection objective 6 does not only capture detection radiation DS from objects 4 at different distances from the first side wall 3.1 in the direction of the z-axis but also captures emitted, scattered, and/or reflected detection radiation DS, for example from the debris 5 present.

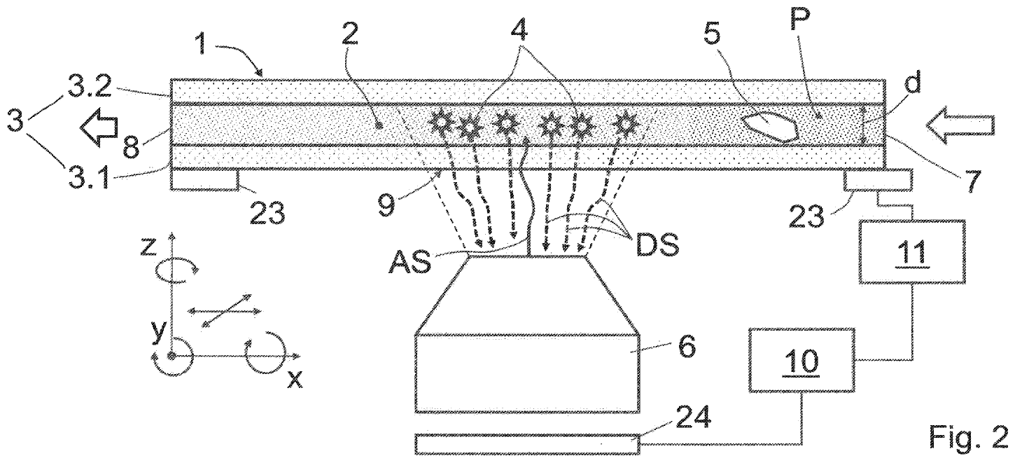

By contrast, the detection radiation DS captured from marked objects 4 using a sample carrier 1 originates virtually exclusively from precisely these marked objects 4 (FIG. 2).

The clear distance d of the sample carrier 1 according to the first exemplary implementation is no more than 50 μm and advantageously less than 25 μm, in particular no more than 5 μm, between the first side wall 3.1 and the second side wall 3.2. In comparison with sample carriers 1 according to the prior art (see FIG. 1), the clear distance d is significantly smaller, with the result that only small objects 4 such as viruses and very small debris 5 can even reach into the sample space 2. To be able to fill the sample carrier 1 with a medium, for example a rinsing medium or the sample P, the sample carrier 1 has an access opening 7 located on an end side of the sample carrier 1. An outlet opening 8 is present so that a medium already present in the sample space 2 during the filling procedure, be it a previously examined sample P, a rinsing medium, an inert gas, and/or air, can escape. A possible flow direction during the filling procedure is specified by arrows.

To cause the detection radiation DS, an excitation radiation AS can be radiated through the wall 3 and into the sample space 2 by means of the detection objective 6. The excitation radiation AS causes the markers of the marked objects 4 to emit a fluorescent radiation in particular as detection radiation DS, which can be captured through the first side wall 3.1. The first side wall 3.1 thus acts as a detection window 9. The excitation radiation AS can be provided by a light source and shaped and/or filtered by means of optical elements (none of which are shown) and can be coupled into the beam path of the detection objective 6. In further implementations, the excitation radiation AS can be radiated—in by means of a separate objective 25 (not shown here; see FIG. 8).

The detection radiation DS collected by means of the detection objective 6 can be imaged on a detector 24, optionally after passing through further optical elements (not shown), and can be captured in the form of measured values by said detector. The detector 24 can be connected to a control unit 10 in the form of a computer, which is optionally configured to evaluate the measured values and generate control commands. The control commands can be used to control a drive 11 which, in turn, moves a sample stage 23, on which the sample carrier 1 is situated, when the received control commands are executed. The movements of the sample stage 23 caused in this way can be translations in each direction of the axes x, y, z and tilt movements or rotations about each of the axes x, y, z, either on an individual basis or as overlaid movements (symbolized by arrows at the coordinate system).

Moreover, there may be feedback between the drive 11 and control unit 10 in order to match a current alignment and/or movement of the sample carrier 1 to an irradiation by the excitation radiation AS and/or to the capture of the detection radiation DS. The described options for moving the sample stage 23 or sample carrier 1 apply accordingly to all exemplary implementations.

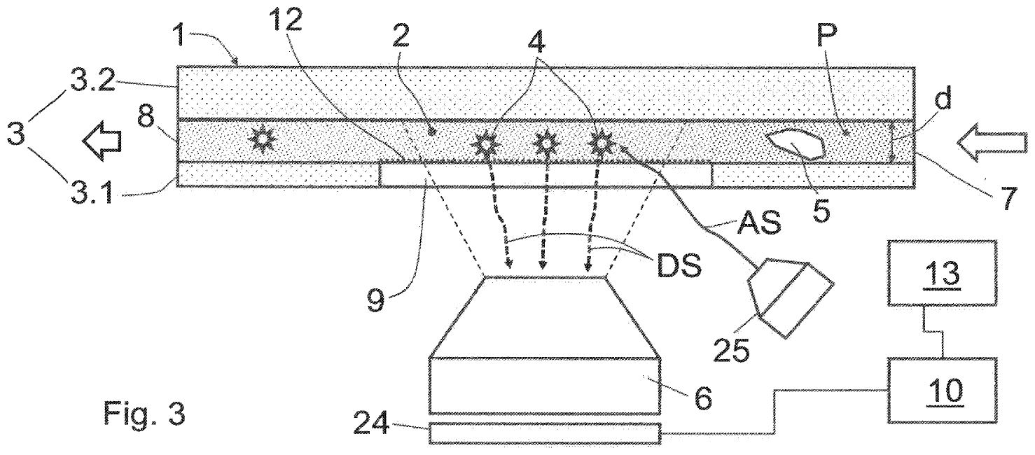

In a second exemplary embodiment, the sample carrier 1 has a second side wall 3.2 that is thicker in comparison with the first side wall 3.1 in order thereby to improve the stability of the sample carrier 1 vis-à-vis loads by bending and/or torsion (FIG. 3). A detection window 9 enabling a low-loss of passage of the detection radiation DS is formed over a portion of the first side wall 3.1. At the same time, the excitation radiation AS can be radiated into the sample space 2 through the detection window 9, wherein the excitation radiation AS is directed into the sample space 2 by means of a further objective 25 in this exemplary embodiment.

On its inner side facing the sample space 2, the detection window 9 may be provided with a coating 12, to which the objects 4 bind specifically. In this way, a relatively large number of objects 4 present are concentrated in the region of the detection window 9.

In further implementations, a coating 10 may be present on further or all inner regions of the wall 3. This is advantageous in particular if the detection radiation DS can also be captured through the wall 3 outside of the explicitly formed detection window 9. By way of example, detection radiation DS of other or further wavelengths may be capturable through the wall 3.

A pump 13 is present in the second exemplary implementation, said pump being controllable by means of the control unit 10 and the action of said pump allowing the sample P and optionally further media such as rinsing media and reaction media to be conveyed into or through the sample space 2. The pump 13 can also be combined with all other exemplary implementations.

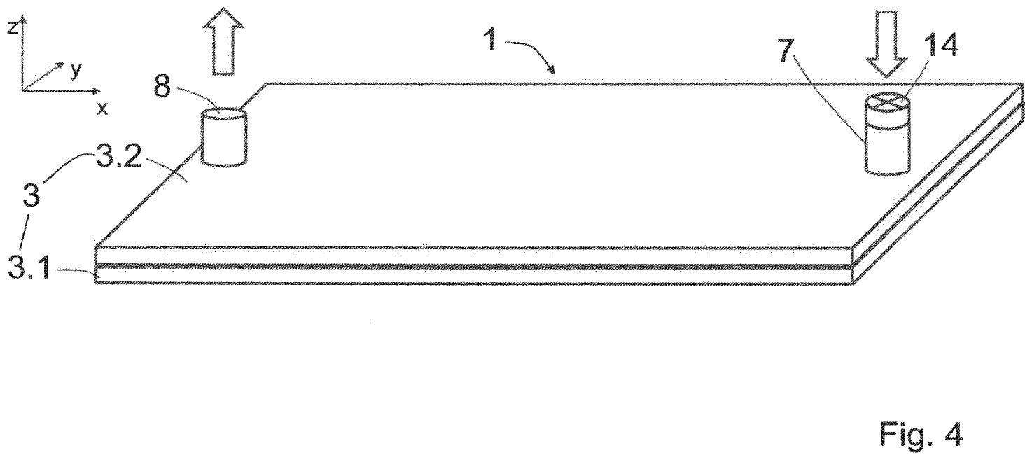

FIG. 4 shows a third exemplary implementation of a sample carrier 1 in a perspective view. The access opening 7 is attached the second side wall 3.2 in the form of a tube and allows the sample P to be filled into the sample space 2 (not shown here). A mechanical filter 14 is present at the opening of the access opening 7; its mesh size is no more than 80% of the clear distance d of the sample space 2. This filter 14 prevents the ingress of debris 5 with a size of more than 80% of the clear distance d into the sample space 2. The outlet opening 8, once again in the form of a tube, is also attached to the second side wall 3.2. The detection radiation DS is captured through the first side wall 3.1 in particular in the direction of the z-axis.

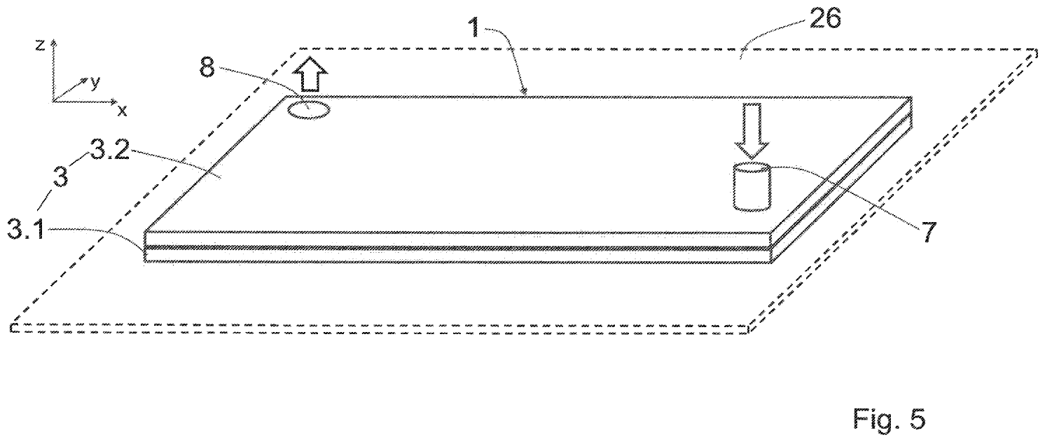

A fourth exemplary implementation of the sample carrier 1 has an access opening 7 in the form of a tube attached to the second side wall 3.2 and an outlet opening 8 in the form of an aperture in the second side wall 3.2 (FIG. 5). The sample carrier 1 is on an optionally present chip 26 (symbolized by a dashed line). In addition to the sample carrier 1, such a chip 26, which may be in the form of a microfluidic chip in particular, can also comprise elements and structures such as channels, reaction chambers, light guides and small motor-driven elements such as motors, pumps, light sources and the like.

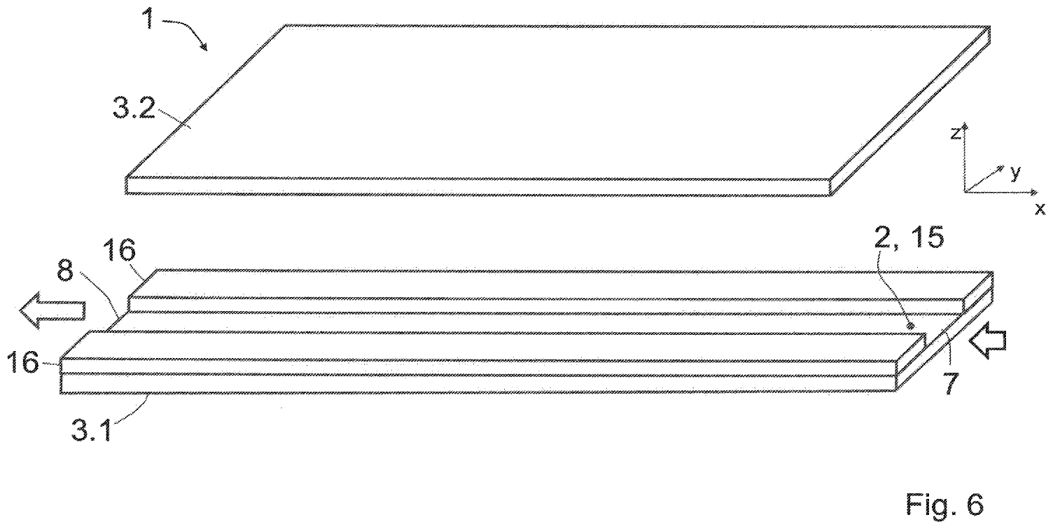

The sample space 2 can be embodied in the form of a channel 15, which extends from the access opening 7 to the outlet opening 8 (FIG. 6). A lateral boundary of the channel 15 can be created by a raised edge 16 attached to the first side wall 3.1 or by spacers placed on the first side wall 3.1. In this case, the first side wall 3.1 serves as a carrier plate. The sample carrier 1 is assembled by placing and optionally securing the second side wall 3.2

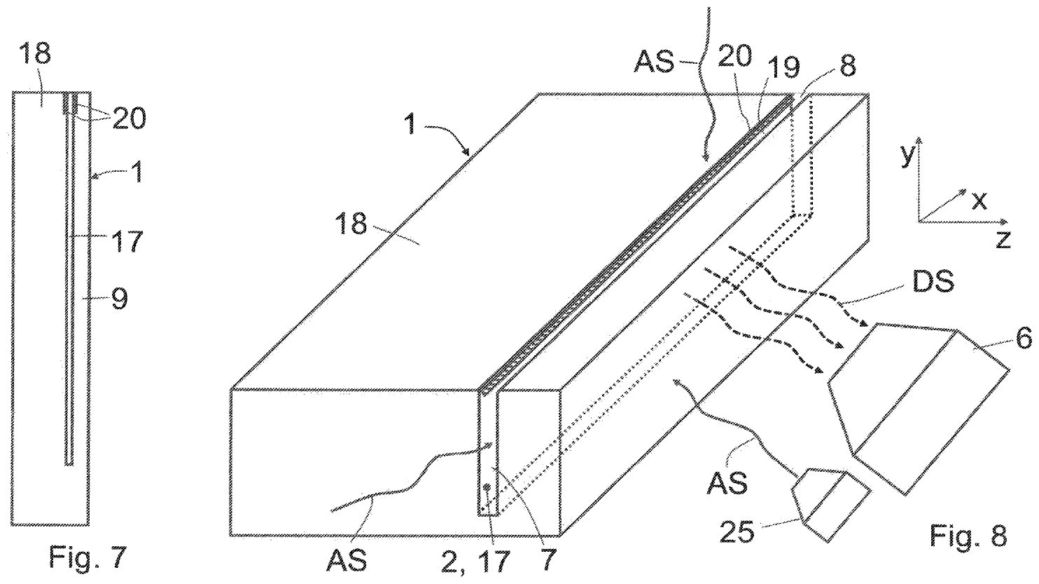

A sixth implementation option for the sample carrier 1 has a slot-shaped channel 17 in a carrier plate 18 as a sample space 2, said channel being open on three sides (FIG. 7 and FIG. 8). Optionally, a coating 20 which cannot be wetted by the sample P is applied along a longitudinal opening 19 of the slot-shaped channel 17. The sample P is kept in the slot-shaped channel 17 on account of the acting capillary forces. The detection radiation DS can be captured through a part of the carrier plate 18. To this end, it is advantageous if the slot-shaped channel 17 is separated from the surroundings by only a thin wall thickness of the carrier plate 18 (detection window 9) at least on one of its longitudinal sides.

Moreover, various options for radiating the excitation radiation AS into the sample space 2 are shown on the basis of FIG. 8, by way of example for all exemplary implementations. One of the options consists of radiating the excitation radiation AS through a lateral wall, in particular through the thinner lateral wall, of the slot-shaped channel 17. It is likewise possible to radiate the excitation radiation through the access opening 7 and/or through the outlet opening 8. In the specific case of the sixth implementation option, the excitation radiation AS can also be radiated into the sample space 2 through the longitudinal opening 19. The excitation radiation AS is advantageously radiated—in by means of an objective 25.

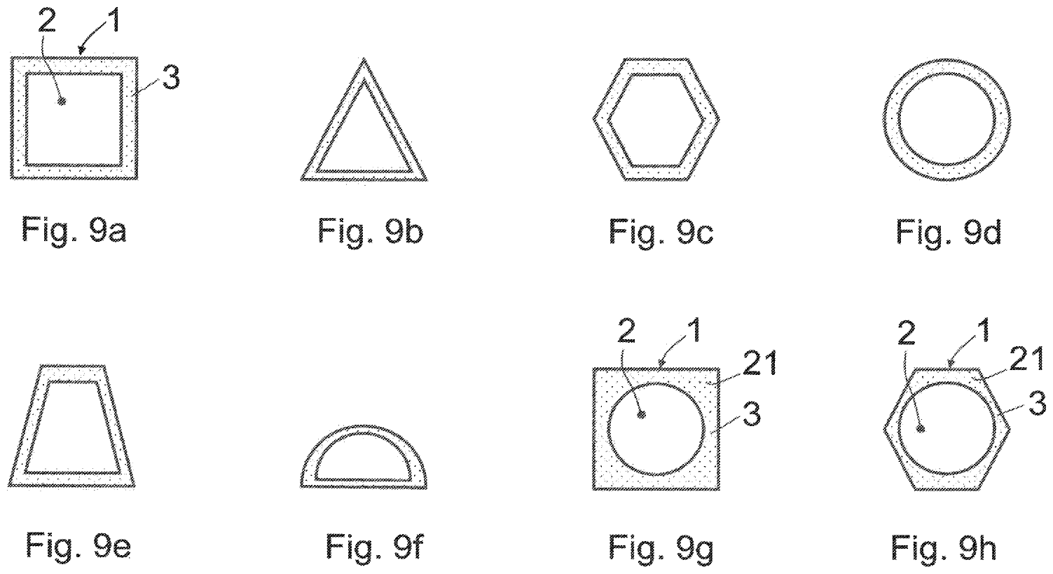

FIGS. 9a to 9h show examples of different cross sections of the sample carrier 1. Only some figures have been provided with reference signs for reasons of clarity. In this case, the cross section of the sample carrier 1 can be quadrilateral (FIG. 9a), triangular (FIG. 9b), hexagonal (FIG. 9c), round (FIG. 9d), trapezoidal (FIG. 9e) or semicircular or flattened (FIG. 9f), wherein the shape of the cross section of the sample space 2 corresponds to the cross section of the outer wall 3. In these cases, the excitation radiation AS and the detection radiation DS each strike two interfaces running parallel to one another. If the irradiation is implemented perpendicular to the interfaces, then arising aberrations can be reduced.

A deviating design of the cross sections is also possible, as shown by way of example and FIGS. 9g and 9h. As a consequence of the round inner cross section, the wall 3 is thicker in the region of the corners, whereby the stability of the sample carrier 1 is supported. These reinforced corner regions can be considered to be inner reinforcements 21, as these are formed below the outer side of the wall 3.

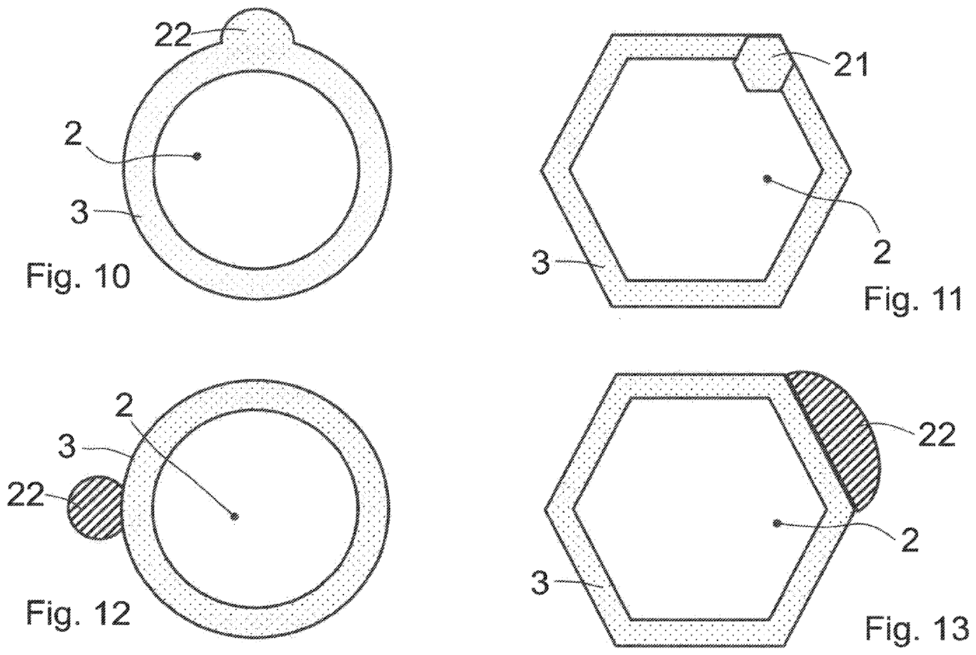

Further options for stabilizing the sample carrier 1 are depicted by way of example in FIGS. 10 to 13. In the exemplary implementation according to FIG. 10, the wall 3 has an outwardly protruding attachment or rib as an outside reinforcement 22, which brings about a stabilization, especially against bending loads arising. In this example, the outside reinforcement 22 is formed as part of the wall 3.

An example of an inside reinforcement 21 is depicted in FIG. 11. To this end, an interior element is additionally worked—in or formed as part of the wall 3 in a corner region of the sample space 2 and the wall 3. In further implementations, such inside reinforcements 21 can be formed in other or further corner regions.

A stabilization can also be achieved by virtue of attaching or applying reinforcing elements to the outer side of the wall 3. By way of example, FIG. 12 shows an adapted round rod as an outside reinforcement 22. In FIG. 13, a semicircular rod is applied to an outer region of the wall 3. An outer reinforcement 22 can be embodied with other cross sections in further implementations.

### REFERENCE SIGNS

1 Sample carrier
2 Sample space
3 Wall
3.1 First side wall
3.2 Second side wall
4 Object/virus
5 Debris
6 Detection objective
d Clear distance
7 Access opening
8 Outlet opening
9 Detection window
10 Control unit
11 Drive
12 Coating (sample-philic to the sample P)
13 Pump
14 Filter
15 Channel
16 Raised edge/spacer
17 Slot-shaped channel
18 Carrier plate
19 Longitudinal opening
20 Coating (sample-phobic to the sample P)
21 Inside reinforcement
22 Outside reinforcement
23 Sample stage
24 Detector
25 Objective (excitation radiation AS)
26 Chip
AS Excitation radiation
DS Detection radiation
P Sample, sample medium

1-15. (canceled)

16. A sample carrier comprising:
a sample space that is enclosed by a wall and that is configured to receive a sample, the wall having at least one transparent region which is transparent to a detection radiation originating from the sample and which acts as a detection window, wherein in a direction perpendicular to the transparent region of the wall, the sample space has a clear distance between opposing inner sides of the wall of no more than 50 μm;
an access opening configured for filling the sample space with the sample; and
an excitation window configured for radiating an excitation radiation into the sample space.

17. The sample carrier as claimed in claim 16, wherein the sample space has a clear distance between opposing inner sides of the wall of no more than 25 μm.

18. The sample carrier as claimed in claim 16, wherein the sample space has a clear distance between opposing inner sides of the wall of no more than 5 μm.

19. The sample carrier as claimed in claim 16, wherein the sample space has a clear distance between opposing inner sides of the wall of no more than 1 μm.

20. The sample carrier as claimed in claim 16, wherein the clear distance is effected between the side walls by virtue of spacers being inserted between opposing side walls or a raised edge being applied to or formed on at least one of the side walls.

21. The sample carrier as claimed in claim 16, wherein the sample space is embodied in the form of a coverable channel present in a carrier plate.

22. The sample carrier as claimed in claim 16, wherein at least one inside reinforcement is present along an inner side of the wall and/or at least one outside reinforcement is present along an outer side of the wall, with the wall being reinforced against deformations as a result of the inside reinforcement and/or as a result of the outside reinforcement.

23. The sample carrier as claimed in claim 16, further comprising a filter element arranged at the access opening, the filter element having a mesh size of no more than 80% of the clear distance.

24. The sample carrier as claimed in claim 23, wherein the filter element has a mesh size of no more than 50% of the clear distance.

25. The sample carrier as claimed in claim 16, wherein at least one region of the inner side of the wall facing the sample space, of the detection window, includes a coating for specifically binding constituents of the sample.

26. The sample carrier as claimed in claim 25, wherein the coating contains poly-L-lysine, poly-D-lysine, and/or collagen.

27. The sample carrier as claimed in claim 16, further comprising an outlet opening configured to allow a previously present medium and/or previously present sample to escape from the sample space when the sample space is filled.

28. The sample carrier as claimed in claim 16, further comprising an immersion medium.

29. A method for capturing detection radiation from a sample in sample space of a sample carrier, wherein the sample space is enclosed by a wall having at least one transparent region which is transparent to detection radiation originating from the sample and which acts as a detection window, wherein in a direction perpendicular to the transparent region of the wall the sample space has a clear distance between opposing inner sides of the wall of no more than 50 μm, wherein the sample carrier includes an access opening configured for filling the sample space with the sample and an excitation window configured for radiating an excitation radiation into the sample space, the method comprising:
introducing the sample into the sample space via the access opening;
illuminating the sample situated in the sample space with excitation radiation that is radiated into the sample space, wherein emission of detection radiation is effected by the effect of the excitation radiation on the sample; and
capturing the detection radiation from the sample through the detection window through a detection objective onto a detector.

30. The method as claimed in claim 29, wherein the sample includes microorganisms and/or pathogens present and the detection radiation emanates from the microorganisms and/or pathogens present in the sample.

31. The method as claimed in claim 29, wherein the sample is transported continually or sequentially through the sample space.

32. The method as claimed in claim 29, further comprising repeatedly exciting the sample with the excitation radiation to emit detection radiation.

33. The method as claimed in claim 29, further comprising rotating or tilting the sample carrier while the detection radiation is captured, such that the detection radiation is captured from different regions of the wall.

34. The method as claimed in claim 29, further comprising rotating or tilting the sample carrier between two capturing processes for the detection radiation, such that the detection radiation is captured from different regions of the wall during the different capturing processes.
